(19) United States
(12) Patent Application Publication
(10) Pub. No.: US 2021/0278246 A1
(43) Pub. Date: Sep. 9, 2021

(54) ROTATOR POSITION DETECTING DEVICE

(71) Applicant: Nanjing Chervon Industry Co., Ltd., Nanjing (CN)

(72) Inventor: Zhongquan Xu, Nanjing (CN)

(21) Appl. No.: 17/158,429

(22) Filed: Jan. 26, 2021

(30) Foreign Application Priority Data
Mar. 5, 2020 (CN) 202010146506.9

(51) Int. Cl. G01D 5/14

(52) U.S. Cl. CPC G01D 5/145

(57) ABSTRACT

A rotator position detecting device includes a magnetic ring, a calculation unit, and at least two Hall sensors. The magnetic ring is secured on a rotator. The magnetic ring includes at least one pair of magnetic poles, and the at least one pair of magnetic poles are distributed in a radial direction of the magnetic ring. The at least two Hall sensors are circumferentially spaced apart along an outer peripheral surface of the magnetic ring or disposed opposite to an end surface of the magnetic ring. The at least two Hall sensors are configured to detect magnetic field strength of the magnetic ring. The calculation unit is configured to calculate, according to the magnetic field strength detected by each of the at least two Hall sensors, a position of the rotator.

### RELATED APPLICATION INFORMATION

This application claims the benefit of CN 202010146506.9, filed on Mar. 5, 2020, the disclosure of which is incorporated herein by reference in its entirety.

### BACKGROUND

When a rotator working in a rotating manner, such as a shaft part or a hub part, rotates, the position of the rotator changes continuously. Generally, a motor includes a stator and a rotor. To accurately control the motor, the position of the rotor needs to be detected.

### SUMMARY

The present disclosure adopts the technical solutions described below by way of non-limiting examples.

A rotator position detecting device includes a magnetic ring, at least two Hall sensors and a calculation unit.

The magnetic ring is configured to be secured on a rotator, the magnetic ring includes at least one pair of magnetic poles, and the at least one pair of magnetic poles are distributed in a radial direction of the magnetic ring.

The at least two Hall sensors are circumferentially spaced apart along an outer peripheral surface of the magnetic ring or disposed opposite to an end surface of the magnetic ring, and the at least two Hall sensors are configured to detect magnetic field strength of the magnetic ring.

The calculation unit is configured to calculate, according to the magnetic field strength detected by each of the at least two Hall sensors, a position of the rotator.

The at least one pair of magnetic poles are one pair of magnetic poles, the at least two Hall sensors are two Hall sensors, and the two Hall sensors are circumferentially spaced by 90° and disposed around the magnetic ring.

The rotator position detecting device further includes a circuit board, the at least two Hall sensors are circumferentially spaced apart along the outer peripheral surface of the magnetic ring, and the at least two Hall sensors each are vertically disposed on the circuit board.

The circuit board is disposed on one side of the outer peripheral surface of the magnetic ring, and the circuit board is disposed around a portion of the magnetic ring in a circumferential direction of the magnetic ring.

The circuit board is disposed around an outer periphery of the magnetic ring.

The circuit board is provided with supporting feet. The supporting feet each are provided with a mounting hole.

The rotator position detecting device further includes a sensor supporting frame, the sensor supporting frame is securely connected to the circuit board, and the sensor supporting frame is provided with accommodating holes for accommodating the at least two Hall sensors.

The rotator position detecting device further includes a magnetic ring mounting seat and a magnetic ring protecting sleeve, the magnetic ring mounting seat is configured to be securely connected to the rotator, and the magnetic ring mounting seat and the magnetic ring protecting sleeve are configured to clamp the magnetic ring in an axial direction of the magnetic ring.

The magnetic ring mounting seat is snapped into the magnetic ring such that the magnetic ring is limited from rotating with respect to the magnetic ring mounting seat.

The rotator is a rotor of a motor, and the at least two Hall sensors are secured to a housing or a stator of the motor.

### BRIEF DESCRIPTION OF DRAWINGS

FIG. 1 is a structural diagram illustrating a rotator position detecting device applied to a motor according to example one of the present disclosure;

FIG. 2 is an exploded diagram illustrating a structure of FIG. 1;

FIG. 3 is a diagram illustrating a partial structure of FIG. 1;

FIG. 4 is a top view illustrating a structure of FIG. 3;

FIG. 5 is a diagram illustrating a partial structure of FIG. 3;

FIG. 6 is a top view illustrating a structure of FIG. 5;

FIG. 7 is an output curve diagram obtained by a rotator position detecting device according to example one of the present disclosure;

FIG. 8 is a structural diagram of a rotator position detecting device applied to a motor according to example two of the present disclosure;

FIG. 9 is an exploded diagram illustrating a structure of FIG. 8; and

FIG. 10 is a top view illustrating a partial structure of FIG. 8.

### DETAILED DESCRIPTION

Examples of the present disclosure will be described in detail below with reference to the drawings where the same or similar reference numerals indicate the same or similar elements or elements having the same or similar functions from the beginning to the end of the disclosure. The examples are intended to explain the present disclosure and are not to be construed as limiting the present disclosure.

In the description of the present disclosure, unless explicitly specified and defined otherwise, terms “connected to each other”, “connected” or “secured” is to be construed in a broad sense, for example, may be a secured connection, a detachable connection, or an integral connection; may be a mechanical connection, or an electrical connection; may be a direct connection or a connection via an intermediate medium; and may be a connection between interiors of two elements, or an interaction between two elements. For those of ordinary skill in the art, the above terms can be construed according to specific cases in the present disclosure.

In the present disclosure, unless otherwise expressly specified and limited, when a first feature is described as “on” or “below” a second feature, the first feature and the second feature may be in direct contact or may be in contact via another feature between the two features instead of being in direct contact. In addition, that the first feature is “on”, “above” or “over” the second feature includes that the first feature is right above or obliquely above the second feature or just indicates that the horizontal level of the first feature is higher than the horizontal level of the second feature. That the first feature is “under”, “below” or “beneath” the second feature indicates that the first feature is right below or obliquely below the second feature or just indicates that the horizontal level of the first feature is lower than the horizontal level of the second feature.

The technical solution of the present disclosure is further described below through specific examples in conjunction with the drawings.

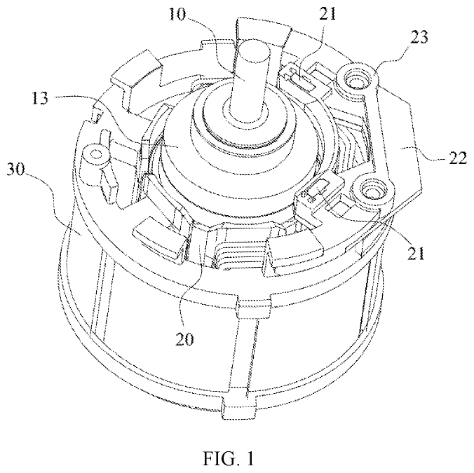

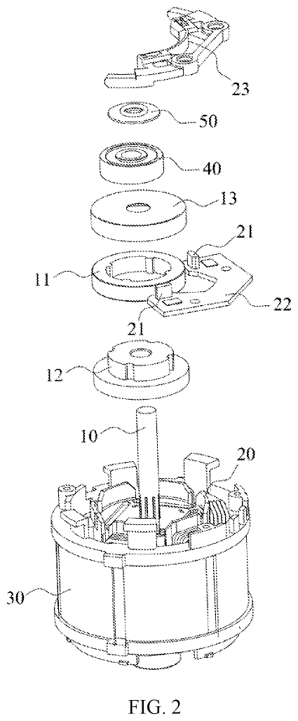

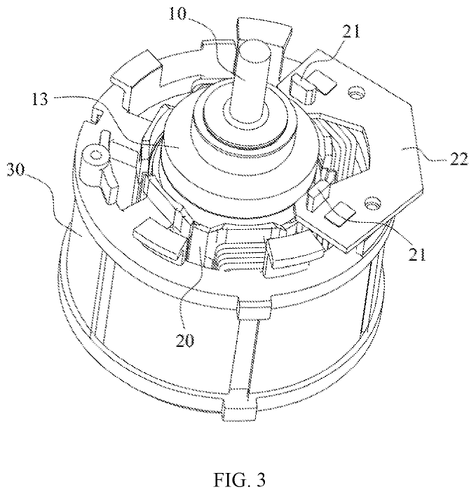

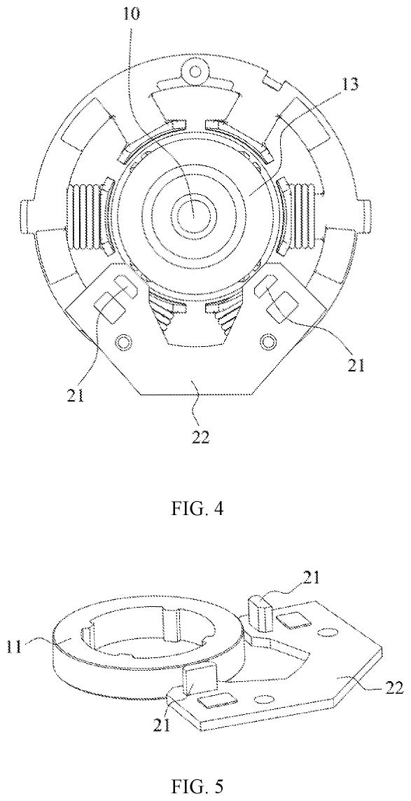

Referring to FIGS. 1 to 7, an example of the present disclosure provides a rotator position detecting device capable of detecting the position of a rotator. Here, the rotator may be a revolving body having a central axis and capable of rotating about the central axis, such as a rotor 10 of a motor or other rotatable portions.

The rotator position detecting device includes a magnetic ring 11, a calculation unit, and at least two Hall sensors 21. The magnetic ring 11 is secured on the rotator, the magnetic ring 11 includes at least one pair of magnetic poles, and the at least one pair of magnetic poles are distributed in a radial direction of the magnetic ring 11. In this example, the at least two Hall sensors 21 are circumferentially spaced apart along an outer peripheral surface of the magnetic ring 11 and are configured to detect magnetic field strength of an outer surface of the magnetic ring 11; and the calculation unit is configured to calculate, according to the magnetic field strength detected by each of the at least two Hall sensors 21, the position of the rotator.

When the rotator rotates about the central axis, the magnetic ring 11 is driven by the rotator to rotate, the Hall sensors 21 can detect the magnetic field strength of the outer surface of the magnetic ring 11, the calculation unit calculates, according to the magnetic field strength detected by each of the at least two Hall sensors 21, the position of the rotator, so that and thereby any one position of the rotator in a circumferential direction can be detected, thereby and achieving full detection is implemented. The magnetic poles are distributed in the radial direction of the magnetic ring 11 so that it is convenient for the Hall sensors 21 to detect. Positions of the Hall sensors 21 are set not to occupy the axial space, thereby facilitating spatial arrangement and making the structure to be compact in the axial direction. A spatial position of the rotator can be obtained according to a signal output by the Hall sensors 21, thereby facilitating control.

In this example, the rotator position detecting device is described below using the rotor 10 of the motor as an example of the rotator. A motor includes a housing 30, a rotor 10, a stator 20 and a stator winding. The stator winding is securely connected to the stator 20, the rotor 10 of the motor is disposed inside the stator 20, and a motor shaft may be securely connected to the rotor 10 of the motor. When the stator winding is powered, a magnetic field can be generated, and the rotor 10 of the motor rotates under the action of the magnetic field so that the motor shaft is driven to rotate. The Hall sensors 21 are secured to the housing 30 or the stator 20 of the motor.

Optionally, the magnetic ring 11 is connected, through a magnetic ring mounting seat 12 and a magnetic ring protecting sleeve 13, to the rotator. The magnetic ring mounting seat 12 is securely connected to the rotator, and the magnetic ring mounting seat 12 and the magnetic ring protecting sleeve 13 are configured to clamp the magnetic ring 11 in the axial direction of the magnetic ring 11. On one hand, the magnetic ring 11 is protected; and on the other hand, the magnetic ring 11 is firmly secured to the rotator, thereby ensuring detection accuracy.

In this example, the magnetic ring mounting seat 12 is sleeved on the rotor 10 of the motor, and the connection between the magnetic ring mounting seat 12 and the rotor 10 of the motor may be a keyed connection, or an interference fit, or a connection through fasteners.

The magnetic ring 11 is sleeved on the magnetic ring mounting seat 12, and the magnetic ring mounting seat 12 includes a supporting part and a mounting part. The supporting part and the mounting part form a stepped shape. The magnetic ring 11 is sleeved on the mounting part, one end of the magnetic ring 11 abuts against the supporting part, and the magnetic ring protecting sleeve 13 is sleeved on the magnetic ring 11 and abuts against the other end of the magnetic ring 11.

The magnetic ring protecting sleeve 13 is also sleeved on the rotor 10 of the motor. To limit the axial position of the magnetic ring protecting sleeve 13, a bearing 40 may be mounted on the rotor 10 of the motor and on the side of the magnetic ring protecting sleeve 13 away from the magnetic ring mounting seat 12, and a gasket 50 is disposed on one side of the bearing 40.

The magnetic ring mounting seat 12 is snapped into the magnetic ring 11 such that the magnetic ring 11 is limited from rotating with respect to the magnetic ring mounting seat 12. Specifically, an outer peripheral surface of the magnetic ring mounting seat 12 is provided with grooves, and an inner wall of the magnetic ring 11 is provided with protrusions that can be inserted into the grooves. When the magnetic ring 11 is sleeved on the magnetic ring mounting seat 12 in the axial direction, the protrusions are inserted into the grooves such that the magnetic ring 11 is secured to the magnetic ring mounting seat 12 in the circumferential direction. In this example, the grooves are disposed on an outer peripheral surface of the mounting part.

The rotator position detecting device further includes a circuit board 22, and the Hall sensors 21 each are vertically disposed on the circuit board 22. The Hall sensors 21 are mounted vertically so that the sensing area is increased, the sensitivity is improved, and the measurement effect is ensured.

In this example, the circuit board 22 is disposed on the outer side of the outer peripheral surface of the magnetic ring 11, and the circuit board 22 is disposed around a portion of the magnetic ring 11 in a circumferential direction of the magnetic ring 11. Since the circuit board 22 faces the peripheral surface of the magnetic ring 11, the Hall sensors 21 can detect any one position of the rotator in the circumferential direction. A signal of the Hall sensor 21 can be transmitted, through the circuit board 22, to a control device.

In order to stabilize the position of the Hall sensor 21, the rotator position detecting device further includes a sensor supporting frame 23. The sensor supporting frame 23 is securely connected to the circuit board 22, and the sensor supporting frame 23 is provided with accommodating holes for accommodating the Hall sensors 21. The Hall sensors 21 are disposed through the accommodating holes such that the positions of the Hall sensors 21 are limited. At the same time, the sensor supporting frame 23 is connected to the stator 20 such that the position of the circuit board 22 is limited.

In this example, the number of magnetic poles is one pair, the number of the Hall sensors 21 is two, and the two Hall sensors 21 are circumferentially spaced by 90° and disposed in the circumferential direction of the magnetic ring 11. After receiving signals of the two Hall sensors 21, an arctangent is performed on the two signals such that the position of the rotator is obtained. The one pair of magnetic poles are an N pole and an S pole respectively, both the N pole and the S pole are semi-annular and are represented by N and S in the figure.

Of course, the number of magnetic poles may be set to be two pairs, the number of Hall sensors 21 may be set to be at least three. As the number of magnetic poles increases, the number of the Hall sensors 21 increases, no more redundant descriptions herein. The number of Hall sensors 21 may be set according to actual requirements for the purpose of obtaining the position of the rotator.

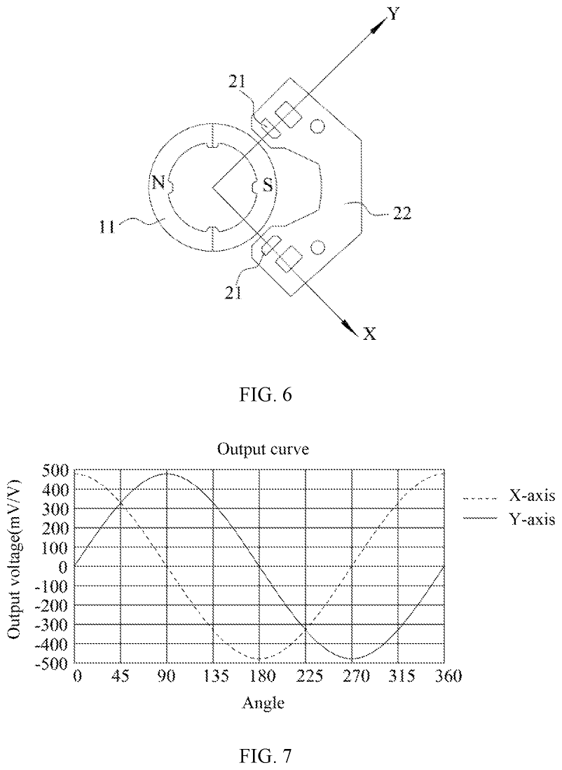

Referring to FIG. 6, the axis of one Hall sensor 21 is disposed on the X-axis and an axis of the other Hall sensor 21 is located on the Y-axis, and the angle between the X-axis and the Y-axis is 90°. Assuming that a voltage value detected by the Hall sensor 21 of the Y-axis is U1, and a voltage value detected by the Hall sensor 21 of the X-axis is U2, a rotational angle of the rotator θ=arctan(U1/U2), so that the position of the rotator can be obtained.

Referring to FIG. 7, the voltage value detected by the Hall sensor 21 located on the X-axis is represented by a dotted line, the voltage value detected by the Hall sensor 21 located on the Y-axis is represented by a solid line. Both the dotted line and the solid line are sine curves, and the phase angle of the dotted line is different from the phase angle of the solid line by 90°.

In this example, the circuit board 22 is U-shaped, and the circuit board 22 is disposed around a portion of the magnetic ring 11 in the circumferential direction of the magnetic ring 11. The circuit board 22 has two end portions. The two end portions of the circuit board 22 each are provided with a Hall sensor 21, and the mechanical angle between the two Hall sensors 21 is 90°.

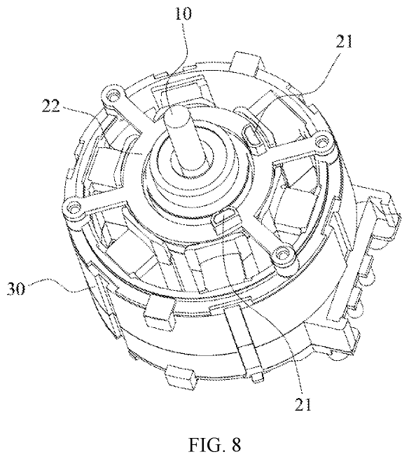

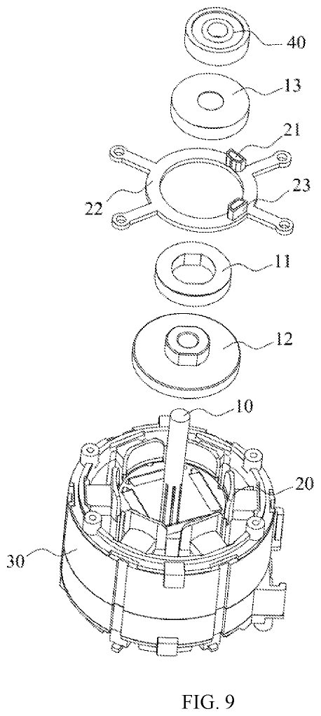

FIGS. 8 to 10 illustrate an example two, where the components same as or corresponding to the example one use the reference numerals corresponding to example one. For the sake of simplicity, only differences between example two and example one are described. The difference is that the circuit board 22 is disposed around the outer periphery of the magnetic ring 11 so that the circuit board 22 is kept away from a vent port of a wire groove on the motor, and heat dissipation of the motor is facilitated.

The circuit board 22 is provided with supporting feet. The supporting feet each are provided with a mounting hole. The supporting feet each are securely connected, through fasteners, to the housing 30 of the motor. The fasteners are disposed through the mounting holes. In this example, the circuit board 22 is provided with four supporting feet in the circumferential direction of the circuit board 22, and each supporting foot is provided with one mounting hole.

In this example, the sensor supporting frame 23 is disposed around an outer periphery of the Hall sensors 21 and has a small volume so that the vent hole is avoided being shielded.

In this example, the outer peripheral surface of the mounting part of the magnetic ring mounting seat 12 is provided with a notch, and the inner wall of the magnetic ring 11 is provided with a protrusion corresponding to the notch. When the magnetic ring 11 is sleeved on the magnetic ring mounting seat 12 in the axial direction, the protrusion abuts against the notch, so that the magnetic ring 11 is secured to the magnetic ring mounting seat 12 in the circumferential direction.

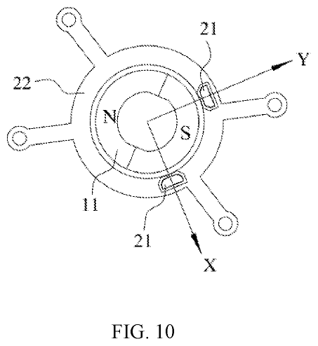

Referring to FIG. 10, the axis of one Hall sensor 21 is located on the X-axis and an axis of the other Hall sensor 21 is located on the Y-axis, and an angle between the X-axis and the Y-axis is 90°. Assuming that a voltage value detected by the Hall sensor 21 of the Y-axis is U1, and a voltage value detected by the Hall sensor 21 of the X-axis is U2, a rotational angle of the rotator θ=arctan(U1/U2), so that the position of the rotator can be obtained.

For the sake of simplicity, only differences between example three and example one are described. The difference is that the at least two Hall sensors 21 are disposed opposite to an end surface the magnetic ring 11 and are configured to detect magnetic field strength of the end surface of the magnetic ring 11; and the calculation unit is configured to calculate, according to the magnetic field strength detected by each of the at least two Hall sensors 21, the position of the rotator.

When the rotator rotates about the central axis, the magnetic ring 11 is driven by the rotator to rotate, the Hall sensors 21 can detect the magnetic field strength of the end surface of the magnetic ring 11, and thereby the position of the rotator can be detected. The Hall sensors 21 occupy a small space, thereby facilitating the spatial arrangement and making the structure to be compact in the axial direction. The spatial position of the rotator can be obtained according to the signals output by the Hall sensors 21, thereby facilitating control.

Specifically, the two Hall sensors 21 are circumferentially spaced apart and disposed around the axis of the magnetic ring 11.

In this example, the circuit board 22 may be disposed on one side of the outer peripheral surface of the magnetic ring 11, or disposed on one side of the end surface of the magnetic ring 11, or disposed on the outer periphery of the magnetic ring 11 or on one end of the magnetic ring 11. The position of the circuit board 22 is not limited herein, so long as the Hall sensor 21 can face the end surface of the magnetic ring 11.

Furthermore, the Hall sensors 21 are horizontally disposed on the circuit board 22 so that the sensing area between the Hall sensors 21 and the magnetic ring 11 is increased, the sensitivity is improved, and the measurement effect is ensured.

The above examples describe only the basic principles and characteristics of the present disclosure and the present disclosure is not limited to the above examples. Various modifications and changes according to the present disclosure which do not depart from the spirit and scope of the present disclosure fall within the scope of the present disclosure. The scope of the present disclosure is defined by the appended claims and equivalents thereof.

What is claimed is:

1. A rotator position detecting device, comprising:
a magnetic ring, configured to be secured on a rotator and comprising at least one pair of magnetic poles, wherein the at least one pair of magnetic poles are distributed in a radial direction of the magnetic ring;
at least two Hall sensors, circumferentially spaced apart along an outer peripheral surface of the magnetic ring or disposed opposite to an end surface of the magnetic ring, wherein the at least two Hall sensors are configured to detect magnetic field strength of the magnetic ring; and
a calculation unit, configured to calculate, according to the magnetic field strength detected by each of the at least two Hall sensors, a position of the rotator.

2. The rotator position detecting device of claim 1, wherein the at least one pair of magnetic poles are one pair of magnetic poles, the at least two Hall sensors are two Hall sensors, and the two Hall sensors are circumferentially spaced by 90° and disposed around the magnetic ring.

3. The rotator position detecting device of claim 1, further comprising a circuit board, wherein the at least two Hall sensors are circumferentially spaced apart and disposed around the outer peripheral surface of the magnetic ring and the at least two Hall sensors each are vertically disposed on the circuit board.

4. The rotator position detecting device of claim 3, wherein the circuit board is disposed on one side of the outer peripheral surface of the magnetic ring and the circuit board is disposed around a portion of the magnetic ring in a circumferential direction of the magnetic ring.

5. The rotator position detecting device of claim 3, wherein the circuit board is disposed around an outer periphery of the magnetic ring.

6. The rotator position detecting device of claim 5, wherein the circuit board is provided with supporting feet and the supporting feet each are provided with a mounting hole.

7. The rotator position detecting device of claim 3, further comprising a sensor supporting frame, wherein the sensor supporting frame is securely connected to the circuit board and the sensor supporting frame is provided with accommodating holes for accommodating the at least two Hall sensors.

8. The rotator position detecting device of claim 1, further comprising a magnetic ring mounting seat and a magnetic ring protecting sleeve, wherein the magnetic ring mounting seat is configured to be securely connected to the rotator and the magnetic ring mounting seat and the magnetic ring protecting sleeve are configured to clamp the magnetic ring in an axial direction of the magnetic ring.

9. The rotator position detecting device of claim 8, wherein the magnetic ring mounting seat is snapped into the magnetic ring such that the magnetic ring is limited from rotating with respect to the magnetic ring mounting seat.

10. The rotator position detecting device of claim 1, wherein the rotator is a rotor of a motor, and the at least two Hall sensors are secured to a housing or a stator of the motor.

11. A power tool, comprising:
a rotator;
a magnetic ring, configured to be secured on a rotator and comprising at least one pair of magnetic poles, wherein the at least one pair of magnetic poles are distributed in a radial direction of the magnetic ring;
at least two Hall sensors, circumferentially spaced apart along an outer peripheral surface of the magnetic ring or disposed opposite to an end surface of the magnetic ring, wherein the at least two Hall sensors are configured to detect magnetic field strength of the magnetic ring; and
a calculation unit, configured to calculate, according to the magnetic field strength detected by each of the at least two Hall sensors, a position of the rotator.

12. The power tool of claim 11, wherein the at least one pair of magnetic poles are one pair of magnetic poles, the at least two Hall sensors are two Hall sensors, and the two Hall sensors are circumferentially spaced by 90° and disposed around the magnetic ring.

13. The power tool of claim 11, further comprising a circuit board, wherein the at least two Hall sensors are circumferentially spaced apart and disposed around the outer peripheral surface of the magnetic ring and the at least two Hall sensors each are vertically disposed on the circuit board.

14. The power tool of claim 13, wherein the circuit board is disposed on one side of the outer peripheral surface of the magnetic ring and the circuit board is disposed around a portion of the magnetic ring in a circumferential direction of the magnetic ring.

15. The power tool of claim 13, wherein the circuit board is disposed around an outer periphery of the magnetic ring.

16. The power tool of claim 15, wherein the circuit board is provided with supporting feet and the supporting feet each are provided with a mounting hole.

17. The power tool of claim 13, further comprising a sensor supporting frame, wherein the sensor supporting frame is securely connected to the circuit board and the sensor supporting frame is provided with accommodating holes for accommodating the at least two Hall sensors.

18. The power of claim 11, further comprising a magnetic ring mounting seat and a magnetic ring protecting sleeve, wherein the magnetic ring mounting seat is configured to be securely connected to the rotator and the magnetic ring mounting seat and the magnetic ring protecting sleeve are configured to clamp the magnetic ring in an axial direction of the magnetic ring.

19. The power of claim 18, wherein the magnetic ring mounting seat is snapped into the magnetic ring such that the magnetic ring is limited from rotating with respect to the magnetic ring mounting seat.
